(19) United States
(12) Patent Application Publication
(10) Pub. No.: US 2009/0275285 A1
(43) Pub. Date: Nov. 5, 2009

(54) Method and apparatus for wireless synchronization between host media center and remote vehicular devices

(75) Inventors: Zoran Maricevic, West Hartford, CT (US); Jelica Maricevic, West Hartford, CT (US)

Correspondence Address: FSP LLC, P.O. BOX 890, VANCOUVER, WA, 98666, US

(73) Assignee: Zoran Maricevic, West Hartford, CT (US)

(21) Appl. No.: 12/349,629

(22) Filed: Jan. 7, 2009

Related U.S. Application Data
(60) Provisional application No. 61/126,055, filed on May 1, 2008.

(51) Int. Cl. H04B 7/00

(52) U.S. Cl. 455/41.3

(57) ABSTRACT

A system to communicate content between a vehicle and the host media center may include wireless communication logic, digital content storage logic, and logic to operate the wireless communication logic to communicate digital content to or from the host media center upon obtaining proximity either with a wireless residential gateway or with a third-party wireless gateway.

### PRIORITY

This application claims priority under 35 USC 119 to U.S. provisional application 61/126,055, filed on May 1, 2008, and having the title “Method and Apparatus for Wireless Synchronization Between Host Media Center and Remote Vehicular Devices”.

### FIELD

The present invention relates to transfer and synchronization of various media content (music, voice, audio, photos, video) from a host media center to devices comprising a vehicular entertainment system, and placement of a digital store and play device within the vehicle's entertainment system.

### BACKGROUND

State-of-the-art entertainment digital home media centers are represented by the Apple™ Incorporated iTunes™ product. The iTunes application runs with either the McIntosh™ or Windows™ operating systems and resides on a computer which also serves as a web portal for purchasing/downloading various content (movies, TV programs, music videos, music tunes, audio books, podcasts) from the web and/or from other digital storage formats: hard-disks, flash memory, compact disks. Another function iTunes serves is to synchronize, update and stream the content it controls to various remote devices: e.g. Apple TV™, iPods™, iPhones™. However, if the above-mentioned iTunes content is to be enjoyed in a car or other vehicle, the state-of-art approach is to download/copy/synchronize the iTunes content onto a removable device (iPod, iPhone), remove/disconnect the device from the computer running iTunes, take the device to a vehicle, connect via special adapter to the vehicle entertainment system and then drive off.

### BRIEF DESCRIPTION OF THE DRAWINGS

FIG. 1 is an illustration of an embodiment of a home media server, vehicular store and play device linked to vehicle entertainment center and interconnecting wireless network which enables device's synchronization with the home media center.

FIG. 2A is an illustration of an embodiment of components of a vehicular entertainment center, with store and play device mounted in the dashboard section of the vehicle.

FIG. 2B is an illustration of an embodiment of a vehicular entertainment center, with the store and play device mounted in the trunk section of the vehicle.

FIG. 3 is an illustration of an embodiment of a system for communicating digital content between a vehicle and a home media center from a remote location.

### DETAILED DESCRIPTION

This disclosure proposes an apparatus for vehicular entertainment and a method for synchronization of the apparatus to a host digital media center. References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

The iTunes/Apple TV concept may be extended to vehicular entertainment systems. Within a vehicle, an Apple-TV-like device is built into the vehicle, with a user interface available in the dashboard or elsewhere within the vehicle. This digital store and play device wirelessly communicates to the home iTunes-like program via wireless network in order to update its content, store the synchronized content on its storage device (hard drive, flash memory or similar), and play the content on the car entertainment center—if the content is of the audio nature, or on the back-seat video device—for content of a video nature.

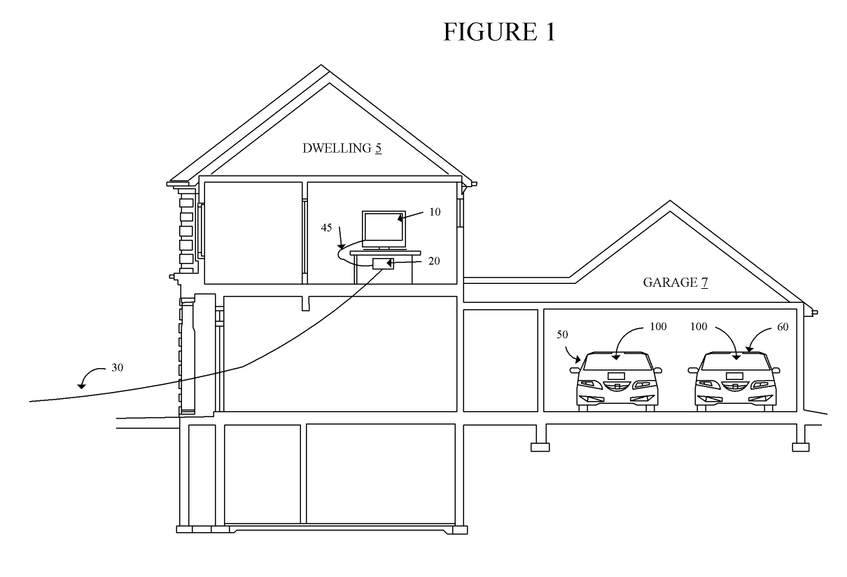

FIG. 1 shows a cross-section of an embodiment of a residential multi-level dwelling with an attached garage with two vehicles parked within it. A media center 10 is linked to Ethernet via routing residential gateway device 20, one example of which is the Linksys WRT54G (and variants WRT54GS, WRT54GL, and WRTSL54GS). These are Wi-Fi capable residential gateways, capable of sharing Internet connections among several computers via 802.3 Ethernet and 802.11b/g wireless data links. The computer is linked to the residential gateway either via cables 45 or wirelessly, and if wirelessly, most often by using one of the 802.11 Wi-Fi wireless standards: type a, b, g, or n, details of which, for example, may be found IEEE 802.11 in the set of standards for wireless local area network (WLAN) computer communication, developed by the IEEE LAN/MAN Standards Committee (IEEE 802), for example in the 5 GHz and 2.4 GHz public spectrum bands.

The residential gateway 20 is connected to the Internet or some other communication network via Ethernet cable 30. The Ethernet link can be of a broadband sort, via cable-modem or DSL modem or via wireless link. It is via the wireless residential gateway 20 that vehicle-located digital store and play device 100 is interconnected to the media center 10, in order to wirelessly connect and synchronize the vehicular device's content with that of the host home media center 10. The proposed functionality may be considered as an extension to the synchronize mode available on Apple TV. However, the digital store and play device is mounted in and intended for use in vehicles 50, 60. The synchronization with the media center 10 takes place while the vehicle is parked within communication range of the residential gateway 20 and within communication range of the resulting home wireless network. FIG. 1 depicts one of the possible scenarios. Other scenarios include and are not limited to use of other type of residential structures: apartment buildings, commercial buildings, ports, airports, bus stations, truck stops, rental car hubs and various vehicles: cars, trucks, boats, planes and motorcycles.

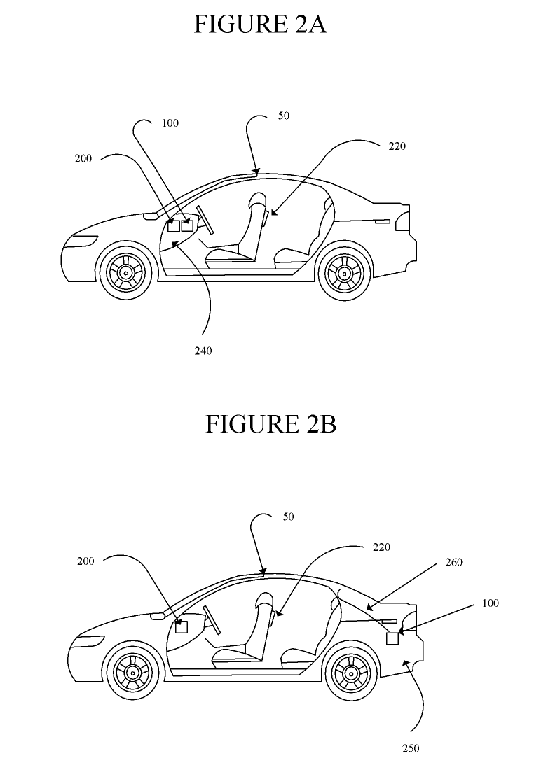

FIG. 2A shows one possible arrangement of the digital store and play device 100 within a vehicle 50. In this arrangement, the store and play digital device is co-located with the vehicle's entertainment system 200, most often located in the vehicle's dashboard 240. For this arrangement, the store and play device 100 may, for example, be factory-installed and connected to the vehicle entertainment system 200, with associated controls and the device user-interface also integrated with vehicle's own entertainment system/computer/navigation graphical user interface. The store and play digital device 100 outputs content of both audio and video nature. However, consumption of the video content is often detrimental to traffic safety while the vehicle is in motion. Thus the system may include a feature of allowing the device 100 to display its video content on a graphical display 220 that's located behind the front row. If the vehicle engine is turned off and the vehicle is not in motion, a possible over-ride of this safety feature may be allowed, and video may play in front. Audio content is assumed to be of lesser consequence to the traffic safety and is thus output directly into the vehicle's own entertainment system 200.

Another safety feature that may be included is disabling video on the front display device, once the parking brake is off, or the vehicle transmission is not in ‘park’. Video, however, is still allowed to go to the back displays. The device may support voice commands and instructions, as opposed to being entirely visual, to minimize the amount of visual interaction that a driver or other person in the vehicle may have to employ.

FIG. 2B shows another possible arrangement of the digital store and play device 100 within a vehicle 50. In this arrangement, the store and play digital device 100 is not co-located with vehicle's entertainment system 200, and is housed elsewhere within the vehicle, for example in the trunk section 250, as is often done with compact disk changers and navigation system database DVDs. For this arrangement, the store and play device 100 may also be factory-installed and connected to the vehicle entertainment system 200, with the associate controls and the device user interface also integrated with vehicle's own entertainment system/computer/navigation graphical user interface. If the digital store and play device is embedded deep within the vehicle's metallic shell, care must be taken in allowing for a good wireless interconnectivity with the host residential gateway via an appropriate wireless antenna 260.

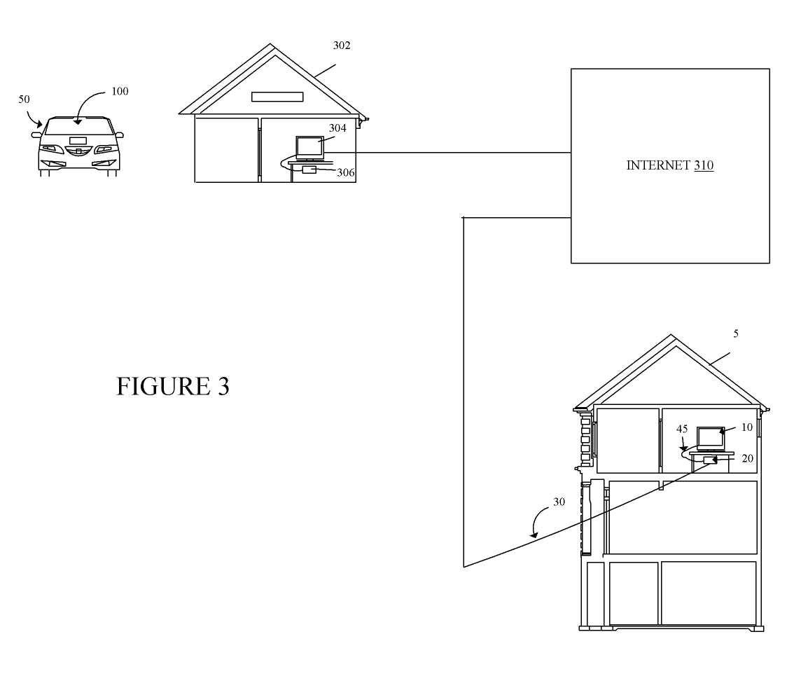

Referring to FIG. 3, in some embodiments, synchronization may occur not when the vehicle is proximate to the home location, but instead, when the vehicle is proximate to a wireless gateway of another location 302. The other location may be a storefront, school, business, hotel, motel, etc. The other location 302 may comprise one or more computer systems 304 and wireless gateways 306. The gateway 306 of the other location may be coupled with the Internet 310 or some other private or public network to the residential gateway location 20. By way of example, a coffee shop or internet café may provide a broadband WiFi hot spot with sufficient bandwidth to enable vehicles to park outside, to synchronize their vehicular entertainment systems with content from residential locations via Internet communications to the home location gateways.

In these scenarios, an authentication process between the vehicle and one or more of the other location gateway 302, Internet 310, and residential gateway 20 may take place. Authentication with the residential gateway 20 may involve a vehicle 50 indentifying the home location gateway 20 by its internet e.g. DNS address and then performing an authentication process with the home gateway 20 in a manner as is known in the art. Some known authentication techniques that may be applied include RADIUS authentication and HTTP authentication, among others.

Once authentication of the vehicle 50 with the home gateway 20 occurs, content may be transferred from the home location gateway 20 to the vehicular entertainment system 100. In some scenarios, the content that is transferred may be specific or tailored to the synchronization location. For example, music suitable for socializing in an Internet café may be transferred when the destination location (e.g. GPS coordinates, location identifier from the store, etc.) indicates such a place. The content that is transferred may also be tailored or selected for the time of day or day of week that the synchronization is occurring. For example, if the day is a holiday, holiday-appropriate music may be transferred to the vehicle 50. When the content is tailored to the vehicle's location, the location may be identified by the synchronization point, e.g. the service provider, or by GPS coordinates, or by a driver of the vehicle, or other methods.

Power Saving Features

The system may incorporate power-saving features to preserve the vehicle's battery power. For example, once the vehicle is parked in the area within wireless access to the host computer, re-synchronization may take place. Once the re-sync is performed, the vehicle-mounted device may go into sleep mode, so that it does not drawn down too much of the vehicle battery power. Even if the re-sync procedure is not complete, but the vehicle battery voltage falls below some safety level, synchronization may be abandoned or postponed, with a message to the same effect logged within the vehicle-mounted device.

During re-sync, only communication and storage components of the vehicular device may be powered, with other components in sleep mode, again in order to preserve battery power.

The foregoing description discloses only exemplary embodiments of the invention. Modifications of the above disclosed apparatus and methods which fall within the scope of the invention will be readily apparent to those of ordinary skill in the art.

Accordingly, while the present invention has been disclosed in connection with exemplary embodiments thereof, it should be understood that other embodiments may fall within the spirit and scope of the invention, as defined by the following claims.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optimal aspects of implementations may involve optimally-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A system to communicate content between a vehicle and the host media center comprising:
wireless communication logic;
digital content storage logic; and
logic to operate the wireless communication logic to communicate digital content to or from the host media center upon obtaining proximity either with a wireless residential gateway or with a third-party wireless gateway.

2. The system to communicate content between a vehicle and the host media center of claim 1, wherein the logic to operate the wireless communication logic to communicate digital content to or from the host media center further comprises:
logic to operate the wireless communication logic only if there is sufficient vehicle battery power to communicate the digital content.

3. The system to communicate content between a vehicle and the host media center of claim 2, wherein the logic to operate the wireless communication logic only if there is sufficient vehicle battery power to communicate the digital content further comprises:
logic to initiate wireless communication with the host media center only if there is sufficient vehicle battery power.

4. The system to communicate content between a vehicle and the host media center of claim 2, wherein the logic to operate the wireless communication logic only if there is sufficient vehicle battery power to communicate the digital content further comprises:
logic to terminate communication of the digital content if the vehicle battery power falls below a sufficient level.

5. The system to communicate content between a vehicle and the host media center of claim 1, further comprising:
logic to determine if adequate safety conditions exist to render video content on front displays of the vehicle.

6. The system to communicate content between a vehicle and the host media center of claim 5, wherein the logic to determine if adequate safety conditions exist to render video content on front displays of the vehicle further comprises:
logic to disable video display on front displays but not displays that are not in the front when the vehicle is in motion.

7. The system to communicate content between a vehicle and the host media center of claim 1, further comprising:
logic to request and-or provide content that is specific to a vehicle location, time of day, day of week, holiday, or event.
